(19) United States
(12) Patent Application Publication
(10) Pub. No.: US 2020/0338755 A1
(43) Pub. Date: Oct. 29, 2020

(54) FOLDING BOX STACK TRANSFERRING DEVICE IN A PACKAGING MACHINE, AND METHOD FOR TRANSFERRING A FOLDING BOX STACK IN A PACKAGING MACHINE

(71) Applicant: IWK VERPACKUNGSTECHNIK GMBH, Stutensee (DE)

(72) Inventor: Thomas BEHRINGER, Bietigheim (DE)

(21) Appl. No.: 16/961,493

(22) PCT Filed: Jan. 8, 2019
(86) PCT No.: PCT/EP2019/050329

§ 371 Date: Jul. 10, 2020

(30) Foreign Application Priority Data
Jan. 11, 2018 (DE) 10 2018 000 161.0

(51) Int. Cl. B25J 15/06; B25J 15/02; B65B 69/00; B65G 47/91; B65G 65/00; B65H 5/00

(52) U.S. Cl. CPC B25J 15/0691; B25J 15/0293; B65B 69/00; B65G 47/91; B65G 65/00; B65H 2701/1764; B65G 2201/022; B65G 2207/08; B65H 2301/42242; B65H 2406/34; B65H 2555/31; B65H 5/006

(57) ABSTRACT

A folding box stack transferring apparatus in a packaging machine has a gripping apparatus which is arranged on an adjustable manipulator. The gripping apparatus has at least two gripping jaws which can be moved toward one another in a clamping direction and between which the folding box stack can be clamped. In addition, a suction apparatus is provided which can be adjusted by means of an adjusting apparatus in such a way that the suction apparatus can be brought selectively into or out of contact with the surface of the folding box stack. In the case of the transfer of a folding box stack, the suction apparatus is brought into contact with the surface of the folding box stack, and the suction apparatus is activated at least temporarily during the transfer of the folding box stack.

The invention relates to a folding box stack transferring apparatus in a packaging machine, with a gripping apparatus which is arranged on an adjustable manipulator and has at least two gripping jaws which can be moved toward one another in a clamping direction and between which the folding box stack can be clamped, the gripping apparatus being assigned a suction apparatus.

Furthermore, the invention relates to a method for transferring a folding box stack in a packaging machine, in particular by way of a folding box stack transferring apparatus of the abovementioned type, the folding box stack being clamped in between at least two gripping jaws of a gripping apparatus in a clamping direction which preferably corresponds to the stack direction, and the gripping apparatus then being transferred together with the folding box stack by means of a manipulator, a suction apparatus being brought into contact with the surface of the folding box stack, and the suction apparatus being activated at least temporarily during the transfer of the folding box stack.

In a packaging machine and, in particular, what is known as a cartoning machine, a product is packaged in a folding box. The folding box is initially present as a flat, almost planar blank. A multiplicity of corresponding flat folding boxes are stacked on one another with the formation of a folding box stack, the stack direction running perpendicularly with respect to the planar folding boxes.

The folding boxes are stacked outside the packaging machine to form the folding box stack, or are already delivered in a stacked form. They have to be gripped by means of a folding box stack transferring apparatus and inserted into a shaft, from which they are removed individually and one after another at the lower end of the shaft by the packaging machine.

DE 10 2012 107 984 A1 has disclosed bringing the folding box stack into contact, usually in a horizontal orientation, that is to say with a horizontally running stack direction on its two end sides, in each case with a gripping jaw. The two gripping jaws are moved toward one another by means of the drive, as a result of which the folding box stack is compressed in the stack direction and is clamped in between the gripping jaws. Here, the clamping direction coincides with the stack direction. When the gripping apparatus is then lifted by means of a manipulator, for example a jointed arm robot, transverse forces and bending moments act on the folding box stack as a consequence of its weight, which transverse forces and bending moments have to be absorbed by way of the clamping force of the gripping jaws and the friction which occurs between adjoining folding boxes. In addition, dynamic loads act on the folding stack on account of the transferring of the folding box stack. It can occur here that the folding boxes are displaced relative to one another, as a result of which the folding box stack loses its shape and the further handling is difficult, since it cannot be introduced in said deformed state into the shaft. If a folding box slips out of the folding box stack, the folding box stack loses its stability and all the folding boxes fall out of the transferring apparatus, which usually leads to it being necessary for the packaging machine to be stopped, in order to collect the individual folding boxes. In order to avoid this, a suction device which acts on the folding box stack is provided on the holder of the gripping jaws in accordance with DE 10 2012 107 984 A1. As a result, the folding boxes are additionally stabilized during the transferring.

US 2003/0120387 A1 has also disclosed a similar folding box stack transferring apparatus.

In order to receive a folding box stack securely, the gripping jaws should apply a compressive force in the direction of the longitudinal center axis of the folding box stack, and the suction apparatus has to be brought reliably into contact with the upper side of the folding box stack. If folding box stacks of different shape and different diameter are to be transferred by way of the folding box stack transferring apparatus, an adaptation of the shape and the position of the gripping jaws and the suction apparatus is necessary. This is time-consuming and expensive.

The invention is based on the object of providing a folding box stack transferring apparatus of the abovementioned type which can be adapted in a simple way to folding box stacks of different shape and size.

Moreover, a method for transferring a folding box stack in a packaging machine is to be provided, by way of which method folding box stacks of different shape and size can be transferred reliably.

With regard to the apparatus technology, said object is achieved by way of a folding box stack transferring apparatus with the features of claim 1. Said folding box stack transferring apparatus is distinguished by the fact that the suction apparatus can be adjusted by means of an adjusting apparatus relative to the gripping jaws in such a way that the suction apparatus can be brought selectively into or out of contact with the surface of the preferably mentioned or compressed folding box stack.

According to the invention, the basis is also the fundamental consideration of supporting the folding box stack at least temporarily and preferably continuously by way of additional mounts during the transferring operation. For this purpose, the suction apparatus is provided which is brought into contact with the surface of the folding box stack and is then activated, as a result of which the folding box stack is additionally held. It is provided here that the suction apparatus can be adjusted relative to the gripping jaws by means of the adjusting apparatus. By way of said adjustment of the relative position between firstly the gripping jaws and secondly the suction apparatus, a simple adaptation to the geometry of the folding box stack to be received is possible. The gripping jaws can be oriented with the line of action of their clamping force on the longitudinal center axis of the folding box stack, and the suction apparatus can preferably subsequently be brought into contact with the upper side of the folding box stack. In this way, an optimum position of the line of action of the clamping force of the gripping jaws and satisfactory contact of the suction apparatus with the upper side of the folding box stack are ensured.

It is provided in one preferred refinement of the invention that the suction apparatus can be adjusted by means of the adjusting apparatus perpendicularly with respect to the clamping direction of the gripping jaws. The clamping direction of the gripping jaws preferably corresponds to the stack direction of the folding box stack. In its compressed, clamped state, the folding box stack has a structured shell surface which is formed by the folding boxes which lie on one another, and has a groove-like structure. It has been shown that the unevennesses of the shell surface can be compensated for by way of the correspondingly dimensioned suction apparatus, with the result that a great holding force can be transmitted between the suction apparatus and the folding box stack.

It can be provided in one possible refinement of the invention that the folding box stack is oriented horizontally immediately before being received by way of the transferring apparatus, with the result that there is a horizontal stack direction and all the folding boxes are oriented vertically and lie with their lower edge on a set-down surface. If a folding box stack of this type is compressed by the gripping jaws on its opposite end sides and is clamped in between the gripping jaws and the transferring apparatus then lifts the folding box stack, transverse forces and bending moments which are directed perpendicularly downward act on the folding body stack as a consequence of the weight of the folding body stack and as a consequence of dynamic effects. Before lifting of the folding box stack, the suction apparatus is preferably brought into contact from above with the upper side of the horizontally oriented folding body stack and is activated, with the result that there is an additional support, in particular, in the case of lifting of the folding body stack.

In one possible refinement of the suction apparatus, a single, preferably linear sucker which extends in the longitudinal direction of the folding box stack, that is to say in the stack direction, can be provided. As an alternative, it is possible for a plurality of individual suckers to be provided which are preferably arranged at a spacing from one another. The suckers can be arranged in at least one row which runs in the clamping direction, and are preferably supplied by a common vacuum source.

It is provided in one preferred refinement of the invention that the suction apparatus has a suction pad which can be brought into contact with the folding box stack. Associated with the use of a suction pad is the advantage that firstly a large-area or even full-area application of suction forces to the surface of the folding box stack is possible, and that secondly unevennesses of the folding box stack can be compensated for in the case of an elastic deformation of the suction pad.

The suction pad preferably consists of an elastically deformable, foamed plastic material and, in particular, of foam.

The suction pad can consist of an air-permeable material, for example an open-pore or open-celled foam, it also being possible for through openings to be configured in the suction pad in addition thereto.

If the suction pad consists of an air-impermeable material, a multiplicity of through openings should be configured in the suction pad, which through openings are configured, in particular, as through bores and are preferably arranged into a regular grid or pattern.

A jointed arm robot, for example, or else what is known as a collaborative robot (cobot) can be used as manipulator, by means of which the transferring movement for the folding box stack is carried out.

The two gripping jaws can be moved toward one another and, for the release of the folding box stack, also away from one another. Said movement can take place hydraulically, pneumatically or by means of an electric motor, for example a servomotor. It can be provided in one possible refinement of the invention that one gripping jaw is attached fixedly on a longitudinal carrier and the other gripping jaw is held on the longitudinal carrier such that it can be adjusted along a linear guide.

The suction apparatus is preferably mounted on a holder which moves in the direction of the folding box stack by means of the adjusting apparatus and can be withdrawn from the folding box stack. The adjusting apparatus is preferably likewise held on the longitudinal carrier which mounts the gripping jaws.

The adjustment of the suction apparatus can take place pneumatically, hydraulically or by means of a motor, in particular a servomotor.

It is provided in one preferred refinement of the invention that a box-shaped housing is provided, in which the folding box stack can be received. In each case at least one pressure element can be arranged on opposed sides of the housing. It is possible for a clamping force which compresses the folding box stack to be applied by way of the pressure elements to the folding box stack which is arranged in the housing.

The pressure elements can preferably be adjusted by means of a drive apparatus, it being possible for the drive apparatus to be formed by an electric motor or by a hydraulic drive or by a pneumatic drive.

The pressure elements are preferably arranged on the outer side of the housing and in each case penetrate a wall of the housing, with the result that the housing interior space is free of the pressure elements in the case of the insertion of the folding box stack into the housing.

The pressure elements can be adjustable bolts which penetrate the wall of the housing.

With regard to the method, the object above is achieved by way of a method with the features of claim 10. It is provided here that the suction apparatus is brought into contact with the surface of the folding box stack, and the suction apparatus is activated at least temporarily and, in particular, continuously during the transferring of the folding box stack. Here, the suction apparatus is lowered onto the folding box stack by means of an adjusting apparatus only after the folding box stack is clamped in between the gripping jaws by means of the clamping apparatus. It is ensured in this way that the suction apparatus comes into contact with the folding box stack which has already been compressed. In particular, it can be provided that the suction apparatus is activated and attracts the folding box stack by suction and stabilizes it before the folding box stack is lifted by means of the transferring apparatus.

It is provided in accordance with the invention that the suction apparatus is brought into contact with the folding box stack only after the clamping and/or compressing of the folding box stack by means of the gripping jaws. This has the advantage that that surface of the folding box stack which comes into contact with the suckers is preferably compressed in an air-tight manner, with the result that the action of the suction apparatus is improved.

Depending on the shape and configuration of the folding boxes, the amount by which the folding box stack can be compressed is very different. In order to ensure that the folding box stack can be received and compressed and clamped in reliably by the gripping jaws, it can be provided in one development of the invention that the folding box stack is prestressed to a certain extent in the stack direction by means of at least two pressure elements before the attachment of the gripping jaws.

It can be provided in one possible refinement of the invention that the folding box stack is arranged in a box-shaped, upwardly open housing or a box, and is removed from the housing or the box by means of the transferring apparatus. It can be provided here that the pressure elements engage through the housing wall or box wall from the outside on the end sides of the folding box stack. It is possible in this way to apply a prestressing force which compresses the folding box stack to the folding box stack which is situated in the housing or in the box. In this state, the end sides of the folding box stack are lifted up from the wall of the housing or the box, with the result that the gripping jaws can engage into the intermediate space which is formed in this way, and can pass into contact with the folding box stack on the end side. The folding box stack is then compressed and clamped in further by means of the gripping jaws.

A plurality of suckers which are arranged behind one another in the clamping direction and, for example, are activated at the same time are preferably provided for the suction apparatus. As an alternative, a suction pad with the indicated construction can also be used.

The folding box stack is preferably made contact with and compressed on its end sides by means of the gripping jaws. If a folding box stack of this type is lifted without the action of the suction apparatus, the greatest bending moments occur in the center of the folding box stack as a consequence of the weight of the folding box stack. It is preferably therefore provided that the suction apparatus, that is to say at least one of the suckers and, in particular, two or three suckers and/or the suction pad, are/is brought into contact with the surface of the folding box stack in the central region of the length of the folding box stack in that state of the latter, in which it is clamped in between the gripping jaws. In particular, the sucker or suckers and/or the suction pad can be arranged in the two middle quarters of the length of the folding box stack in its compressed state.

Further details and features of the invention can be seen from the following description of one exemplary embodiment with reference to the drawing, in which:

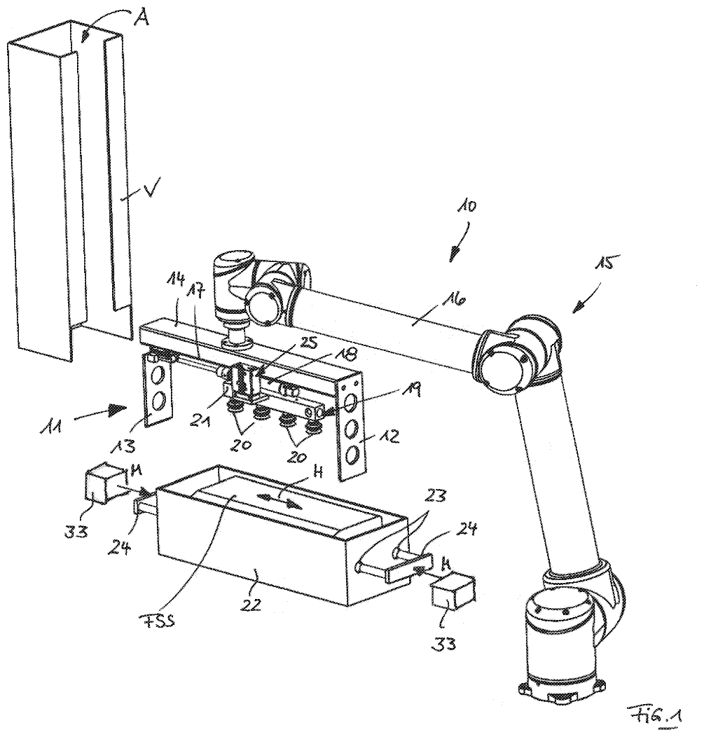

FIG. 1 shows a perspective view of a folding box stack transferring apparatus according to the invention,

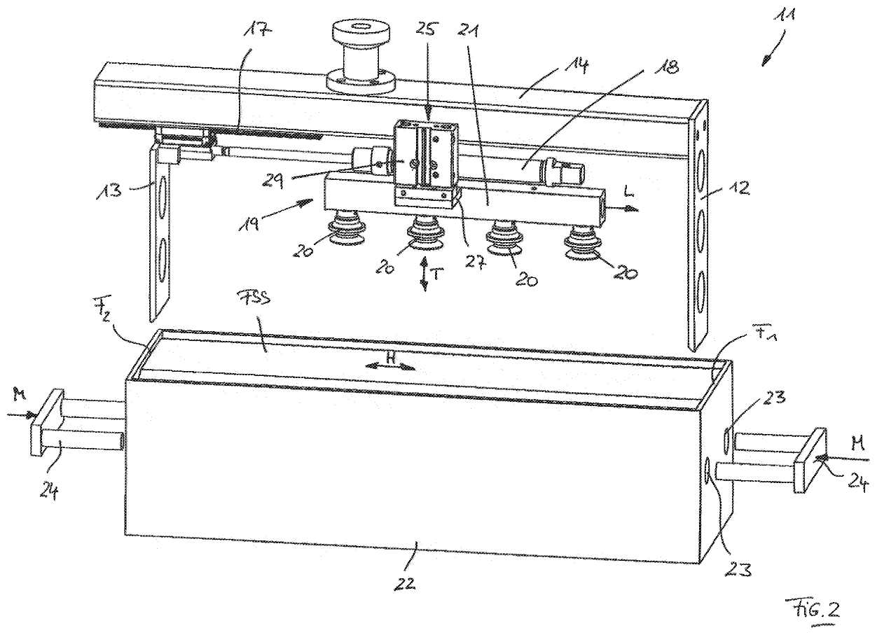

FIG. 2 shows an enlarged illustration of the gripping apparatus and the folding box stack in a first phase of the transferring,

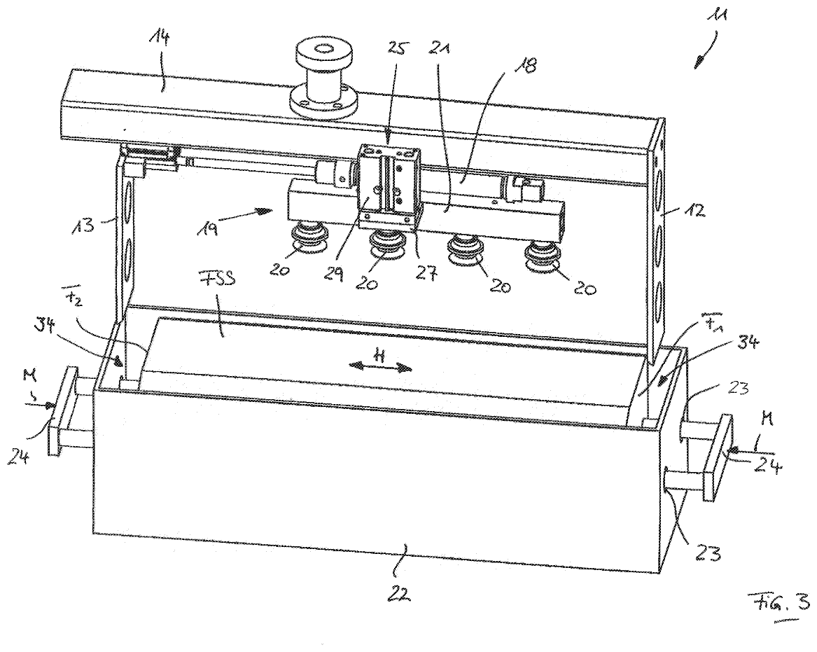

FIG. 3 shows an enlarged illustration of the gripping apparatus and the folding box stack in a second phase of the transferring apparatus,

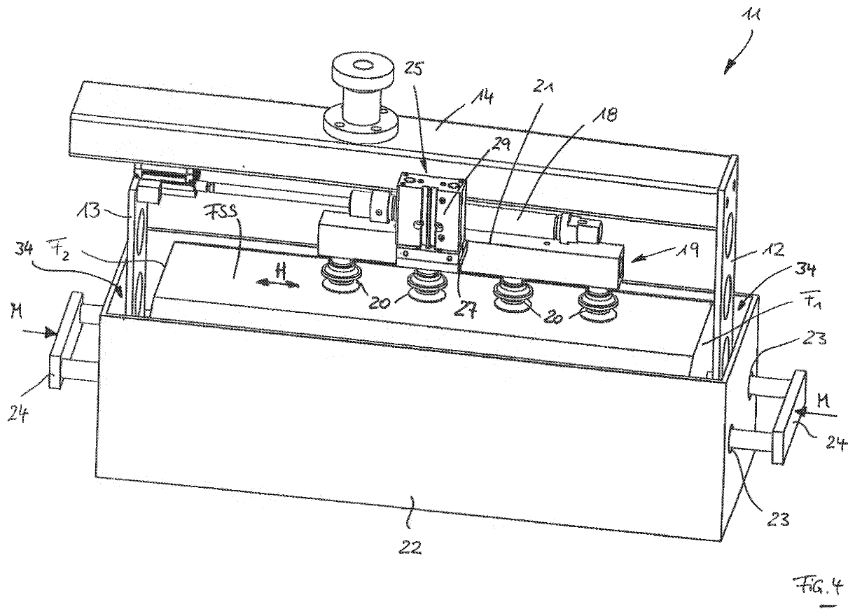

FIG. 4 shows an enlarged illustration of the gripping apparatus and the folding box stack in a third phase of the transferring,

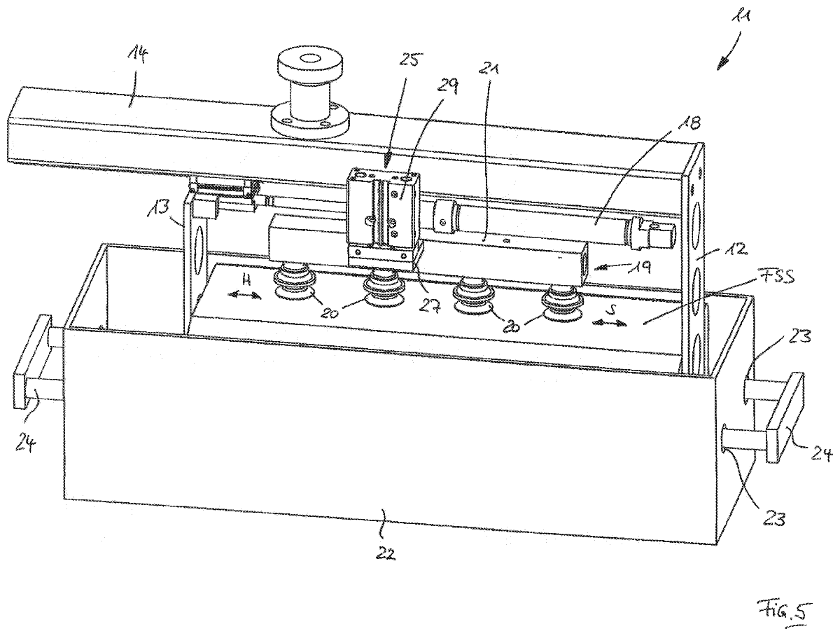

FIG. 5 shows an enlarged illustration of the gripping apparatus and the folding box stack in a fourth phase of the transferring,

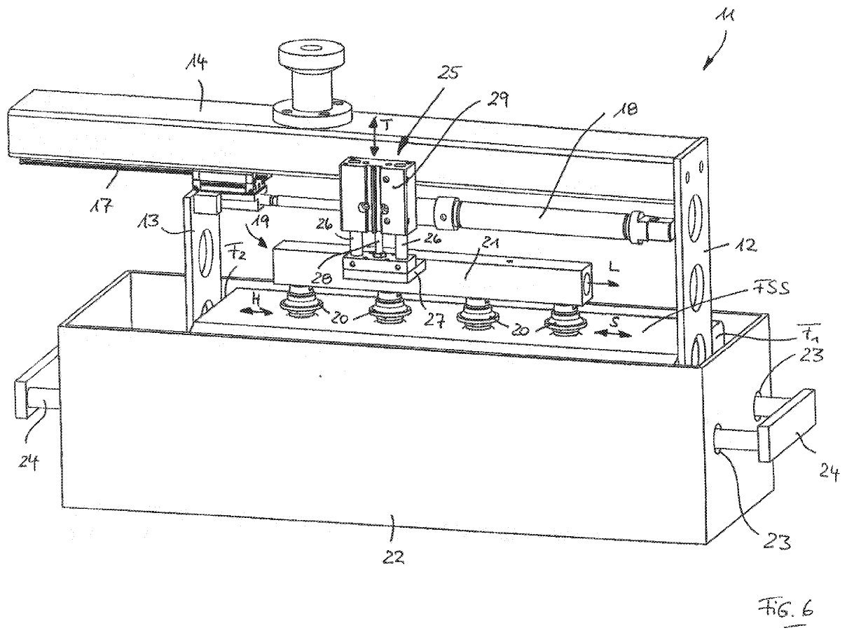

FIG. 6 shows an enlarged illustration of the gripping apparatus and the folding box stack in a fifth phase of the transferring,

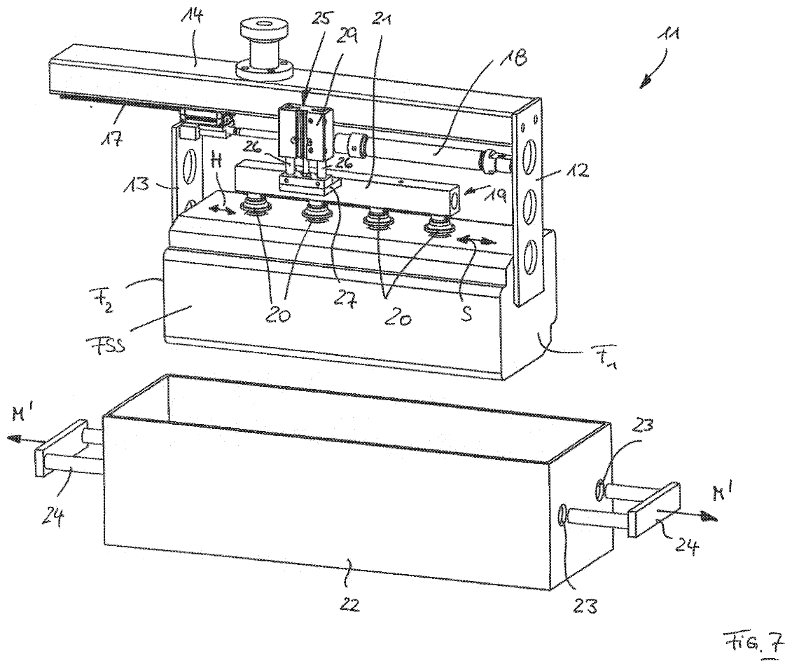

FIG. 7 shows an enlarged illustration of the gripping apparatus and the folding box stack in a sixth phase of the transferring, and

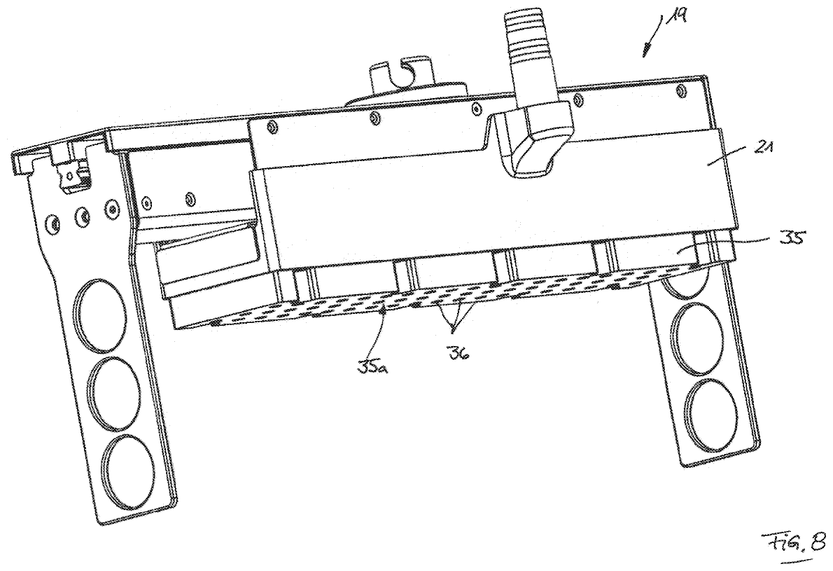

FIG. 8 shows a gripping apparatus with an alternative embodiment of the suction apparatus.

FIG. 1 shows a view of a folding box stack transferring apparatus 10, by means of which a folding box stack FSS can be transferred, which folding box stack FSS is received in a box-shaped housing 22 in a horizontal orientation, that is to say with a horizontal stack direction H. In each case two through holes 23 are configured in the side walls of the housing 22, against which side walls the folding box stack FSS bears with its end sides. In each case one pressure element 24 is arranged outside the housing 22 on the opposed end sides of the folding box stack FSS. Each pressure element 24 penetrates the wall of the housing 22 at the through holes 23 and can be moved in the direction of the folding box stack FSS. For this purpose, each pressure element 24 is assigned a drive apparatus 33, by means of which an adjusting force can be applied to the pressure element 24, as indicated by way of the arrow M. If the pressure elements 24 which are arranged on opposed sides of the housing 22 are moved toward one another, the folding box stack FSS can be compressed or prestressed in the stack direction H.

The folding box stack transferring apparatus 10 is intended to remove the folding box stack FSS from the box-shaped housing 22 and to insert it from above into a vertically oriented shaft V, as indicated by way of the arrow A.

The folding box stack transferring apparatus 10 has a manipulator 15 in the form of a multiple jointed robot 16 which can be configured as a collaborative robot (cobot). At its front end, the manipulator 15 supports a gripping apparatus 11 for receiving the folding box stack FSS. The gripping apparatus 11 comprises a longitudinal carrier 14, at the one end of which one gripping jaw 12 is attached fixedly. A linear guide 17 is arranged on the underside of the longitudinal carrier 14, on which linear guide 17 a further gripping jaw 13 is seated such that it can be displaced. By means of a drive 18, the further gripping jaw 13 can be displaced along the linear guide 17, with the result that the spacing between the gripping jaws 12 and 13 can be increased or decreased.

Furthermore, a suction apparatus 19 is provided with a rod-shaped holder 21 which extends parallel to the longitudinal carrier 14 and, on its underside, supports four suckers 20 which are arranged in a row next to one another at a spacing. The suckers 20 can be loaded with a vacuum, as indicated by way of the arrow L (see FIG. 2).

FIG. 6 shows, in particular, that the holder 21 is connected to an adjusting apparatus 25 via a holding plate 27 which has two vertical holding bars 26 which are guided displaceably into a bearing block 29. A thrust rod 28 is active between the bearing block 29 and the holding plate 27, by way of the activation of which thrust rod 28 the holding plate 27 can be lowered and raised together with the suction apparatus 19 which is fastened to it in the direction of the upper side of the folding box stack FSS, as indicated by way of the double arrow T in FIG. 2.

In the following text, the individual phases of the transferring of the folding box stack FSS from the box-shaped housing 22 into the shaft V are to be described in detail on the basis of FIGS. 2 to 7.

FIG. 2 shows the starting position, the folding box stack FSS being arranged in the upwardly open housing 22 in a horizontal orientation, that is to say with a vertical stack direction H, and bearing with its end sides F₁ and F₂ against the side walls of the housing 22. In order to move the end sides F₁ and F₂ of the folding box stack FSS away from the side walls of the housing 22, the drive apparatuses 33 are activated, as a result of which the pressure elements 24 are introduced from outside through the through holes 23 of the housing 22 and the two pressure elements 24 are moved toward one another, as a result of which the folding box stack FSS is compressed within the housing 22 in the stack direction H by a small amount, as shown in FIG. 3. Here, the end sides F₁ and F₂ are lifted up from the side walls of the housing 22, with the result that intermediate spaces 34 are formed between the end sides F₁ and F₂ and the side walls of the housing (see FIG. 3).

The gripping apparatus 11 is then positioned above the housing 22 in such a way that the vertical gripping jaws 12, 13 are situated in each case precisely above one of the intermediate spaces which are formed between the end sides F₁ and F₂ and the side walls of the housing 22. The gripping apparatus 11 is then lowered by means of the manipulator 15, with the result that the gripping jaws 12 and 13 engage into the intermediate spaces 34 between the end sides F₁ and F₂ of the folding box stack FSS and the walls of the housing 22, as shown in FIG. 4. Here, the suction apparatus 19 is still situated at a spacing above the folding box stack FSS.

In a further step, the drive 18 is activated, as a result of which the left hand (according to FIG. 4) gripping jaw 13 is moved along the linear guide 17 toward the right hand (according to FIG. 4) gripping jaw. The gripping jaws 12 and 13 come into contact with the end sides F₁ and F₂ of the folding box stack FSS and compress the latter in the stack direction H, with the result that the folding box stack FSS is clamped in between the gripping jaws 12 and 13 with tight packing, as shown in FIG. 5. Here, a clamping direction S coincides with the stack direction H.

As soon as the gripping jaws 12 and 13 have reached their desired relative position and the folding box stack FSS is compressed and clamped in to a sufficient extent, the suction apparatus 19 is lowered by means of the activation of the adjusting apparatus 25 to such an extent that the suckers 20 lie on the surface of the folding box stack FSS, as shown in FIG. 6. Subsequently, the suckers 20 are loaded with a vacuum (arrow L), with the result that the folding box stack FSS is attracted by suction by way of the suckers 20. Said state is shown in FIG. 6.

Subsequently, the manipulator 15 is activated which pulls the gripping apparatus 11 vertically upward and therefore removes the folding box stack FSS from the housing 22. In said state which is shown in FIG. 7, the folding box stack FSS is clamped in on its end sides F₁ and F₂ by way of the gripping jaws 12 and 13, and is additionally prevented from falling down by way of the suckers 20 which are placed on the upper surface of the folding box stack FSS. In said state, the folding box stack FSS can be oriented in a desired way by means of the manipulator 15 and can be inserted from above into the shaft V. The pressure elements 24 are withdrawn from the housing 22 by means of the drive apparatuses 33, as indicated in FIG. 7 by way of the arrows M′.

FIG. 8 shows an alternative embodiment of the suction apparatus 19. In the case of the preceding exemplary embodiment, a plurality of individual suckers were provided which are now replaced by way of a suction pad 35 which can consist of foam. The suction pad 35 has a lower-side suction face 35a, with which it is possible to be placed over a large area or even over the full area onto the upper side of the compressed folding box stack FSS in the case of lowering of the suction device 19.

The suction pad 35 consists of an open-pore and therefore air-permeable foam material; in addition to this, however, through openings 36 can also be made in the suction pad 35.

A vacuum chamber (not shown) is configured in the holder 21 on that side of the suction pad 35 which faces away from the folding box stack FSS, with the result that a vacuum can be generated on the suction face 35a of the suction pad 35.

If the suction apparatus 19 is lowered in the stated way onto the upper side of the folding box stack FSS, the suction pad 35 is pressed with its suction face 35a against the upper side of the folding box stack FSS, and a large-area suction and holding force is applied to the folding box stack FSS after a vacuum is applied to the suction face 35a.

1-10. (canceled)

11. The method as claimed in claim 15, further including adjusting the pressure elements by a drive apparatus.

12. The method as claimed in claim 11, wherein the drive apparatus comprises an electric motor or a hydraulic drive or a pneumatic drive.

13. The method as claimed in claim 18, further including penetrating the pressure elements in the wall of the housing.

14. The method as claimed in claim 18, wherein the pressure elements have adjustable bolts which penetrate the wall of the housing.

15. A method for transferring a folding box stack in a packaging machine, the method comprising:
clamping the folding box stack in between at least two gripping jaws of a gripping apparatus in a clamping direction, then transferring the gripping apparatus together with the folding box stack by a manipulator, bringing a suction apparatus into contact with a surface of the folding box stack, and activating the suction apparatus at least temporarily during the transferring of the folding box stack, compressing and prestressing the folding box stack in the clamping direction by at least two pressure elements before the clamping of the gripping jaws, lowering the suction apparatus onto the folding box stack by an adjusting apparatus after clamping the folding box stack in between the gripping jaws by the gripping apparatus.

16. (canceled)

17. The method as claimed in claim 15, wherein the prestressing of the folding box stack takes place in a box-shaped housing.

18. The method as claimed in claim 17, further including moving and displacing the pressure elements through a wall of the housing.

19. The method as claimed in claim 15, further including, after the prestressing of the folding box stack by the pressure elements, introducing the gripping jaws into intermediate spaces between end sides of the folding box stack and walls of the housing.

20. The method as claimed in claim 19, wherein the introducing includes introducing the gripping jaws at the same time into the intermediate spaces.

21. The method as claimed in claim 13, wherein the pressure elements have adjustable bolts which penetrate the wall of the housing.

22. The method as claimed in claim 17, further including adjusting the pressure elements by a drive apparatus.

23. The method as claimed in claim 18, further including adjusting the pressure elements by a drive apparatus.

24. The method as claimed in claim 13, further including adjusting the pressure elements by a drive apparatus.

25. The method as claimed in claim 14, further including adjusting the pressure elements by a drive apparatus.

26. The method as claimed in claim 17, further including, after the prestressing of the folding box stack by the pressure elements, introducing the gripping jaws into intermediate spaces between end sides of the folding box stack and walls of the housing.

27. The method as claimed in claim 18, further including, after the prestressing of the folding box stack by the pressure elements, introducing the gripping jaws into intermediate spaces between end sides of the folding box stack and walls of the housing.

28. The method as claimed in claim 13, further including, after the prestressing of the folding box stack by the pressure elements, introducing the gripping jaws into intermediate spaces between end sides of the folding box stack and walls of the housing.

29. The method as claimed in claim 14, further including, after the prestressing of the folding box stack by the pressure elements, introducing the gripping jaws into intermediate spaces between end sides of the folding box stack and walls of the housing.

30. The method as claimed in claim 11, further including, after the prestressing of the folding box stack by the pressure elements, introducing the gripping jaws into intermediate spaces between end sides of the folding box stack and walls of the housing.

31. The method as claimed in claim 12, further including, after the prestressing of the folding box stack by the pressure elements, introducing the gripping jaws into intermediate spaces between end sides of the folding box stack and walls of the housing.
